(19) United States
(12) Patent Application Publication
(10) Pub. No.: US 2009/0258957 A1
(43) Pub. Date: Oct. 15, 2009

(54) Recycled Plastic Composition

(75) Inventor: Chris Curran, Mildura, Victoria (AU)

Correspondence Address: RICHARD M. GOLDBERG, 25 EAST SALEM STREET, SUITE 419, HACKENSACK, NJ, 07601, US

(73) Assignee: AUSPLAZTIK PTY LTD, Mildura, Victoria (AU)

(21) Appl. No.: 12/299,227

(22) PCT Filed: May 17, 2007
(86) PCT No.: PCT/AU07/00669

§ 371 Date: Oct. 31, 2008

(30) Foreign Application Priority Data
May 17, 2006 (AU) 2006902641

(51) Int. Cl. C08J 11/04

(52) U.S. Cl. 521/47

(57) ABSTRACT

A method of producing settable, strong, rigid, durable and machinable compositions including plastics and organic fibres including the steps of: (a) forming a polyolefin source of plastic into particle sizes about 2 mm to 10 mm in diameter; (b) forming a polystyrene source of plastic into particle about 2 mm to 10 mm in diameter; (c) forming a natural organic fibre source into fibres in a size ranges between 0.2 mm and 5 mm; (d) mixing the above in a ratio between 70% to 20% by weight of a), 60% to 20% by weight of b), and 50% to 10% by weight of c) to form a combination until the combination is substantially mixed; (e) drying the combination of d) at a temperature up to 135° C. until the mixture is stable dry; and (f) mixing and drying the combination of e) thermally and/or mechanically to achieve a moisture content below 1% for the combination.

### CROSS-REFERENCE TO RELATED APPLICATIONS

The present application claims priority from Australian Provisional Patent Application No 2006902641 filed on 17 May 2006, the content of which is incorporated herein by reference.

### INTRODUCTION TO THE INVENTION

This invention relates to synthetic plastic composite materials, and in particular to a plastic composite material utilising recycled plastic materials in conjunction with natural organic fibres to produce a plastic composite material of high strength, durability and machine-ability. Products manufactured from the plastic composite find application in a range of extruded and injection moulded forms including in-ground posts, bollards, decking, fences, artificial bristles and a range of artificial wooden products etc.

### BACKGROUND TO THE INVENTION

Increasing quantity and quality of recyclable thermoplastic materials, makes available a significant resource which is already well utilised in the recycling industry. Recycled plastics materials including low and high density polyethylene and polystyrene plastics are currently utilised in a wide range of recycled products.

Low and High density polyethylene (LDPE and HDPE) are manufactured from the ethylene monomer which is a product derived from processing of crude hydrocarbon oil. Polyethylene (sometimes called polythene) has a wide range of uses including the production of milk bottles, laundry detergent bottles, plastic bags, film used for protection of fruit trees, containers for chemicals, chemical resistant piping systems, etc. Polypropylene is manufactured from the monomer propylene which is also derived from processing of crude hydrocarbon oil and is used in many products similar to those in which polyethylenes are used. Polyethylenes and Polypropylene belong to the family of thermoplastics referred to as polyolefins Polystyrene is a polymer made from the monomer styrene, a liquid hydrocarbon that is commercially manufactured from petroleum. At room temperature, polystyrene is normally a solid thermoplastic, but it can be melted at high temperature for moulding and extrusion and then resolidification. Pure solid polystyrene is a colourless hard plastic with limited flexibility but it can be cast into moulds with fine detail. Polystyrene can be transparent or made to take on various colors. Its an economical plastics material and finds use in a wide range of plastic model assembly kits, plastic cutlery, CD jewel cases and many other every day objects and applications where a reasonably rigid and economical plastic of a variety of colors is required.

In addition, polystyrene's most common form is that of expanded polystyrene, where this form of polystyrene finds use in a range of insulated building panels, moulded packing materials for cushioning, non weight-bearing agricultural structures such as pillars and a wide range of application and crafts model building and architectural models.

This invention relates to the development of a particular wood replacement product which is robust, durable and machinable which evolved from the applicant's endeavours to use recycled plastics materials for the provision of an in-ground post for use in the wine industry. The wine industry currently uses vast quantities of timber posts, including treated pine posts for the in-ground posts used to support vines. Timber posts are an expensive and high maintenance solution to a rapidly expanding market. The majority of vineyard postings currently employed, utilise treated pine materials which have been subject to safety questions, particularly with respect to the leaching of the impregnation materials including arsenic and copper, incorporated in these products. The imperative to replace this type of in-ground post with an environmentally non-reactive material has encouraged the applicants to investigate the use of recycled plastic materials for the provision of such a product. In the process of investigations, the applicants have determined that the strength and workability of current recycled plastics materials was insufficient to provide the necessary workability and durability of the posts required for vineyard systems and experimentation with the addition of natural fibres including sawdust, hemp, etc, has given rise to the unexpected composition of the invention which provides a high level of strength, durability and workability beyond that currently expected and available from plastics recycled in the conventional manner.

It would be desirable to provide an improved binder composition for recycled plastic products when used for production of wood replacement products. In particular, it would be desirable to improve the performance of the said products in thermally variable environments.

### STATEMENTS OF THE INVENTION

Accordingly the invention provides in a first aspect a method of producing a settable, strong, rigid, durable and machinable composition including plastics and organic fibres comprising the steps of:
a) Reducing the size of available polyolefin feedstock by thermal and/or mechanical processing to form particles of size of about 2mm to 10 mm in size, the maximum size being dictated by the requirements of downstream processing equipment;
b) Reducing the size of available polystyrene feedstock by thermal and/or mechanical processing to form particles of about 2mm to 10 mm in size, the maximum size being dictated by the requirements of downstream processing equipment;
c) forming a natural organic fibre source into fibres in a size range between 0.2mm and 5 mm;
d) mixing a combination of the above in a ratio of between 70% to 20% by weight of a), 60% to 20% by weight of b), and 50% to 10% by weight of c) until said combination is substantially mixed. Such mixing can be effected by a variety of techniques including low or high speed mixing
e) drying the combination of step d) at a temperature of up to 135° C. until said mixture is stably dry; and
f) mixing and drying the combination of step e) by thermal and/or mechanical means such as high speed mixing and vacuum drying to achieve a moisture content of below 1% for the combination.

The method may include the additional step of extrusion or injection moulding said composition to provide a formed composition for setting into a desirable shape displaying said strong, rigid, durable and machinable form, forming said combination in an extrusion or injection moulding machine to form said settable, rigid and workable composition.

In another aspect the invention provides a composition and product manufactured in accordance with the method of the invention. The composition may be used to manufacture a range of products as previously mentioned.

The composition may include the following by weight:

TABLE 1

| Product Type | Formula 1 | Formula 2 | Formula 3 | Formula 4 |
|---|---|---|---|---|
| HDPE and/or LDPE | 50% | 60% | 50% | 45% |
| PS | 25% | 20% | 30% | 20% |
| Natural organic fibre | 25% | 20% | 20% | 33% |

Preferably, the composition includes the following by weight:

TABLE 2

| Component | Minimum | Maximum |
|---|---|---|
| Polyolefin | 20% | 70% |
| Polystyrene | 20% | 60% |
| Polyethylene terephthalate | 0% | 50% |
| Organic fibre material | 10% | 50% |

### DETAILED DESCRIPTION OF THE INVENTION

The invention will now be described with respect to a particularly preferred embodiment and four examples of a selection of formulations utilising the particular method and composition of the invention to achieve a recycled plastic composition incorporating natural fibres, which exhibits high levels of strength, rigidity, durability and workability.

Referring to Table 1, a selection of four formulas as particular preferred embodiments are provided, where all the formulations are applied in accordance with the method of the invention, where the method includes the use of recyclable plastics materials from reclaimed kerb-side plastic waste, vine covers or other sources. The recycled plastic wastes are separated into polyolefin products (which are separated into subgroups low and high density polyethylene and polypropylene) and polystyrene products. The plastic products, once separated into their different types, are then granulated with the use of any one or a range of available commercial granulation and processing equipment to a size of between about 2 mm to 10 mm particle size. The natural organic fibre component of the invention is sourced from a range of available fibres including hardwood fibres, softwood fibres, for example red gum Eucalyptus camaldulensis and pine Pinus radiata, but can also include cotton, rice husks, paper, cardboard and hemp. The organic fibres are treated by cutting, crushing or sawing to be prepared into a size range between 0.2 and 5 mm in size.

Once the components of the composition have been prepared, the components are added in accordance with the weight ratio amounts provided in Table 1 into a mixing vessel which is then heated to a temperature of about 135° C. so as to dry and mix the components of the composition thoroughly. The mixing and drying time will depend on the quality of the components used and the mixing and drying step is continued for the amount of time necessary to fully mix and dry the components of the composition.

Once the components are thoroughly mixed and dried, the mixture is then transferred to a high speed mixture and/or vacuum dryer and mixer in order to fully remove the moisture of the volatile components from the natural organic fibres and plastics used in the mixture. This step is continued until the moisture content of the mixture is reduced to below 1%. Once the components have been thoroughly mixed, the preparation is then available for application by way of extrusion or injection moulding. The optional operational temperature with an extruder is preferably run at a temperature between 180 to 210° C., dependent on the type of machine and the thermoplastics used in the formulation.

The extrusion once formed is then allowed to set and dry and the resultant composition exhibits a high level of durability, strength and machinability and can be formed into any suitable shape or configuration including a longitudinal circular post configuration for cutting into posts of a suitable size for use in vineyards. Of course, this can be extended to a range of posts for application to a wide range of situation including farm fencing posts etc, bollards etc. The extrusion can also be configured to produce decking, fencing materials including plinthing and palings, oyster posts etc. The composition of the invention once set and cured, provides a highly workable, drillable, cuttable, nailable and fastenable product highly suited for a wide range of applications.

The composition of the invention utilises the binding and filling function of the natural organic fibres which serve to provide cross-linking, binding, bulking and strength to the composition with the polystyrene component also serving to add cross-linking and strengthening characteristics to the composition once it has set and cured. The advantages of the invention are fully realised only when the components are added and treated in accordance with the method of the invention, which provides unique and unexpected results with clear advantages over all known prior art compositions.

Referring now to Table 2, another example of the composition of the invention incorporates the use of polyethylene terephthalate. The composition can utilise this readily available plastics material and provides similar performance characteristics to the previously described compositions.

The composition of the present invention exhibits excellent compatibility, is uniformly distributed in the final product in a very homogeneous manner, and thus allows the product to exhibit excellent physical integrity both during subsequent processing or in applications in the field

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A method of producing a settable, strong, rigid, durable and machinable composition including plastics and organic fibres comprising the steps of:
(a) forming a polyolefin source of plastic into a particle size of about 2 mm to 10 mm in diameter;
(b) forming a polystyrene source of plastic into a particle size of about 2 mm to 10 mm in diameter;
(c) forming a natural organic fibre source into fibres in a size range between 0.2 mm and 5 mm;
(d) mixing the above in a ratio of between 70% to 20% by weight of a), 60% to 20% by weight of b), and 50% to 10% by weight of c) to form a combination until said combination is substantially mixed;
(e) drying the combination of step d) at a temperature of up to 135° C. until said mixture is stably dry; and
(f) mixing and drying the combination of step e) by at least one of thermal and mechanical assemblies to achieve a moisture content of below 1% for the combination.

2. A method according to claim 1 wherein:
said forming of a polyolefin includes reducing the size of available polyolefin feedstock by at least one of thermal and mechanical processing to form particles of size of about 2 mm to 10 mm in size; and
said forming of a polystyrene includes reducing the size of available polystyrene feedstock by at least one of thermal and mechanical processing to form particles of about 2 mm to 10 mm in size.

3. A method according to claim 1 wherein said polyolefin is selected from at least one of the following:
high density polyethylene, and
low density polyethylene.

4. A method according to claim 1 wherein said at least one of thermal and mechanical assemblies includes high speed mixing and vacuum drying.

5. A method according to claim 1 wherein said step of mixing and drying the combination includes the addition of polyethylene terephthalate.

6. A method according to claim 6 wherein said polyethylene terephthalate is included in a ratio of between 50% to 0% by weight of said combination.

7. A composition formed from a combination of polyolefin, polystyrene and natural organic fibre, produced by a method according to claim 1.

8. A composition according to claim 7 further including polyethylene terephthalate.

9. A composition according to claim 7 comprising by weight 50% polyolefin, 25% polystyrene and 25% natural organic fibre.

10. A composition according to claim 7 comprising by weight 60% polyolefin, 20% polystyrene and 20% natural organic fibre.

11. A composition according to claim 7 comprising by weight 50% polyolefin, 30% polystyrene and 20% natural organic fibre.

12. A composition according to claim 7 comprising by weight 45% polyolefin, 20% polystyrene and 33% natural organic fibre.

13. A composition according to claim 8 comprising by weight between 70% to 20% polyolefin, between 60% to 20% polystyrene, between 50% to 0% polyethylene terephthalate, and between 50% to 10% natural organic fibre.

14. A composition according to claim 7 wherein said natural organic fibre is selected from any one or a combination of hardwood fibres, softwood fibres, cotton, rice husks, paper, cardboard and hemp.

15. A composition according to claim 14 wherein said natural organic fibre is Eucalyptus camaldulensis.

16. Products manufactured from the composition of claim 7, said products including at least one from the group consisting of posts, poles, fencing, decking, bollards, artificial bristles and artificial timber.

17. (canceled)

18. (canceled)

19. (canceled)
